(19) United States
(12) Patent Application Publication
(10) Pub. No.: US 2005/0213135 A1
(43) Pub. Date: Sep. 29, 2005

(54) Facsimile machine, facsimile system and program

(75) Inventors: Kazunobu Asai, Nagoya-shi (JP); Toshiaki Denpo, Nagoya-shi (JP)

Correspondence Address: OLIFF & BERRIDGE, PLC, P.O. BOX 19928, ALEXANDRIA, VA, 22320, US

(73) Assignee: Brother Kogyo Kabushiki Kaisha, Nagoya-shi (JP)

(21) Appl. No.: 11/089,155

(22) Filed: Mar. 25, 2005

(30) Foreign Application Priority Data
Mar. 26, 2004 (JP) 2004-092256

(51) Int. Cl. G06F 13/00; H04N 1/21; H04N 1/00

(52) U.S. Cl. 358/1.13; 358/400; 358/1.15; 358/444

(57) ABSTRACT

When switching of an operating mode is performed while there is data that has not been confirmed yet by a user, that is, unprocessed data that has not been processed yet, remaining in a storage device, the unprocessed data can be processed regardless of whether the user has acknowledged that the unprocessed data remains in the storage device.

### CROSS REFERENCE TO RELATED APPLICATION

This application claims priority from Japanese Patent Application No. 2004-092256, filed Mar. 26, 2004, the subject matter of which is incorporated herein in its entirety by reference thereto.

### BACKGROUND

The subject matter of this disclosure relates to a facsimile machine that records images, which are represented by encoded data obtained from external sources, onto recording mediums.

There has been a facsimile machine whose operating mode can be switched between a recording mode where an image, which is represented by encoded data obtained through facsimile communications, is recorded (printed) onto a recording medium, and a transfer mode where encoded data is transferred to a terminal device that is capable of performing data communications with the facsimile machine. While the facsimile machine operates in the transfer mode, a user can confirm an image represented by encoded data, for example, on a display of the terminal device that received the encoded data from the facsimile machine.

While operating in the transfer mode, the facsimile machine transfers encoded data, which was obtained through facsimile communications, to the terminal device at a predetermined timing (e.g. at the time of receiving encoded data).

### SUMMARY

If, however, the terminal device is not in operation at the time the facsimile machine performs the transfer of encoded data to the terminal device, the encoded data cannot be transferred from the facsimile machine to the terminal device. As a result, the user cannot confirm an image represented by the encoded data, on the terminal device.

In order to avoid the above problem, for example, Japanese Laid-Open Patent Publication No. 2002-135502 discloses a system of transferring encoded data from a facsimile machine to a terminal device, at a predetermined timing, while the terminal device is in operation. More specifically, the transfer of encoded data is performed when a user presses a transfer button to transfer the encoded data to the terminal device, when the facsimile machine detects that the terminal device enters a predetermined status (e.g. TWAIN is up and running), or when a predetermined time is reached.

However, in a case where the conventional facsimile machine is arranged so as to transfer encoded data at at least one of the timings, which are disclosed in Japanese Laid-Open Patent Publication No. 2002-135502, while operating in the transfer mode, if the facsimile machine has encoded data that remains in a memory without transferring the encoded data to the terminal device (e.g. the facsimile machine in the transfer mode received new encoded data through facsimile communications between a first transfer timing and a second transfer timing) and the operating mode of the facsimile machine is switched to the recording mode from the transfer mode in order to record encoded data to be newly received, the encoded data stored in the memory remains therein without the user confirming the stored encoded data.

In such facsimile machines, a volatile memory (e.g. RAM) is commonly used for cost reduction. Therefore, data stored in the memory of the facsimile machine may be erased if the user performs, for example, a restart operation (e.g. a removal and insertion of a plug of the facsimile machine from and into a receptacle), a power shut-off operation (e.g. a removal of the plug from the receptacle), or an erasing operation (e.g. a pressing of an erase button to erase data stored in the memory) on the facsimile machine. Thus, even when there is unconfirmed encoded data stored in the memory, the unconfirmed encoded data may be erased from the memory without the user recognizing it.

The subject matter of this disclosure provides a technique to avoid accidental erasure of unprocessed encoded data whose contents have not been confirmed yet, in a facsimile machine.

According to one aspect of the disclosure a facsimile machine includes a storage device that stores data based on information obtained from an external source, a recording device that records an image represented by the data stored in the storage device, a transfer device that transfers the data stored in the storage device to a terminal device capable of performing data communications, a mode switching device that switches an operating mode of the facsimile machine between a recording mode of recording the image represented by the data stored in the storage device by means of the recording device, and a transfer mode of transferring the image data by means of the transfer device, a data processing device that determines whether there is the data, which has not been recorded or transferred yet, stored in the storage device, and processes the unrecorded or untransferred data by employing one of a plurality of processing methods including at least the processing performed by the recording device and the processing performed by the transfer device, when there is unrecorded or untransferred data in the storage device, at the time the operating mode is switched by the mode switching device.

According to the facsimile machine structured as described above, when the switching of the operating mode is performed while there is data that has not been confirmed yet by the user, that is, unprocessed data that has not been processed yet, remaining in the storage device, the unprocessed data can be processed regardless of whether the user has acknowledged that the unprocessed data remains in the storage device. Therefore, if a user restarts the facsimile machine, turns the power of the facsimile machine off, or performs an operation to erase the data stored in the storage device after the above processing is performed, there is no unprocessed data that has not been confirmed yet by the user remaining in the storage device at that time. Thus, the unprocessed data can be prevented from being accidentally erased while maintained in the storage device.

### BRIEF DESCRIPTION OF THE DRAWINGS

An exemplary embodiment of subject matter of this disclosure will be described in detail with reference to the following figures wherein:

FIG. 1 is a block diagram representing a structure of a facsimile system;

FIG. 2 is a flowchart of a facsimile receiving process;

FIG. 3 is a flowchart of a mode setting process;

FIG. 4 is a continuation of the mode setting process of FIG. 3;

FIG. 5 is a flowchart of a transfer process; and

FIG. 6 is a flowchart of a communications management report output process.

### DETAILED DESCRIPTION OF EMBODIMENT

An exemplary embodiment of the subject matter of this disclosure will be described with reference to the accompanying drawings.

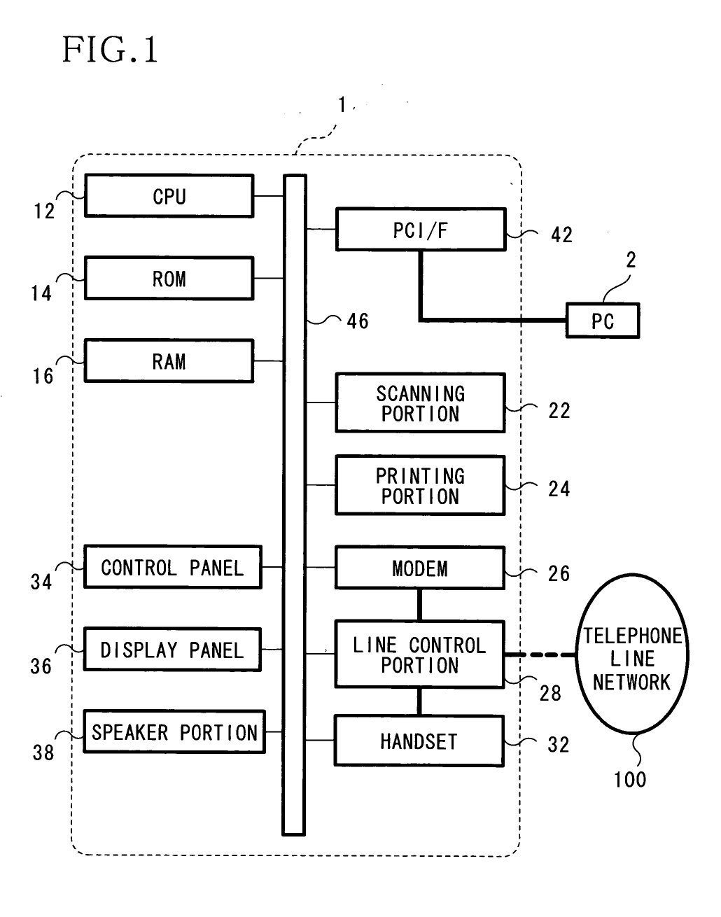

As shown in FIG. 1, a facsimile machine 1 establishes a facsimile system with a personal computer (PC) 2 that is connected to the facsimile machine 1 so as to be able to perform data communications therebetween. The facsimile machine 1 has a function of implementing voice phone and facsimile communications via a telephone line network 100.

The facsimile machine 1 includes a CPU 12, a ROM 14, a RAM 16, a scanning portion 22, a printing portion 24, a modem 26, a line control portion 28, a handset 32, a control panel 34, a display panel 36, a speaker portion 38, and a PC interface (PC I/F) 42, which are connected with each other via a bus 46. The CPU 12 controls operations of the facsimile machine 1. The ROM 14 stores procedures of processes to be executed by the CPU 12. The RAM 16 stores results of processes executed by the CPU 12, and the like. The scanning portion 22 reads a document in order to implement the facsimile communications. The line control portion 28 realizes the facsimile communications and the voice phone. The handset 32 is to be used when removed from a body of the facsimile machine 1. The control panel 34 includes a plurality of keys and switches. The display panel 36 displays various data and information thereon. The speaker portion 38 includes a speaker and a drive circuit that drives the speaker. The PC interface 42 connects the facsimile machine 1 with the PC 2 via a communication cable.

The scanning portion 22 reads an image from a document placed on a predetermined read position (not shown) and generates image data of the read image, upon receipt of a command from the CPU 12.

The modem 26 modulates the image data, which is generated by the scanning portion 22, to generate image signals transmittable through the telephone line network 100, and demodulates image signals, which are inputted from the telephone line network 100 through the line control portion 28, upon receipt of a command from the CPU 12.

The printing portion 24 performs printing of an image based on the image data onto a sheet placed on a predetermined sheet supply position (not shown), upon receipt of a command from the CPU 12.

The line control portion 28 receives various signals inputted from the telephone line network 100 and outputs signals to the telephone line network 100. In addition, upon receipt of a command from the CPU 12, the line control portion 28 defines a transmission line that connects a sender and a receiver of signals to be inputted and outputted between the line control portion 28 and the telephone line network 100. When an operation for sending (faxing) an image is performed through the control panel 34 or when the line control portion 28 receives image signals from the telephone line network 100, a transmission line is established between the line control portion 28 and the modem 26, so that the image signals can be transmitted through the transmission line. When the output of the image signals by the modem 26 is finished or when the input of the image signals by the telephone line network 100 is finished, the transmission line is cancelled, so that the image signals cannot be transmitted therebetween. When the handset 32 is lifted from the body of the facsimile machine 1 (a telephone is off-hook), a transmission line is established between the line control portion 28 and the handset 32, so that voice signals can be transmitted through the transmission line. When the handset 32 is put down on the body of the facsimile machine 1 (the telephone is on-hook), the transmission line is cancelled, so that the voice signals cannot be transmitted therebetween.

The PC interface 42 is provided in order to connect the facsimile machine 1 with the PC 2 via the communication cable. By connecting the facsimile machine 1 and the PC 2, a condition of being capable of performing data communications therebetween is established.

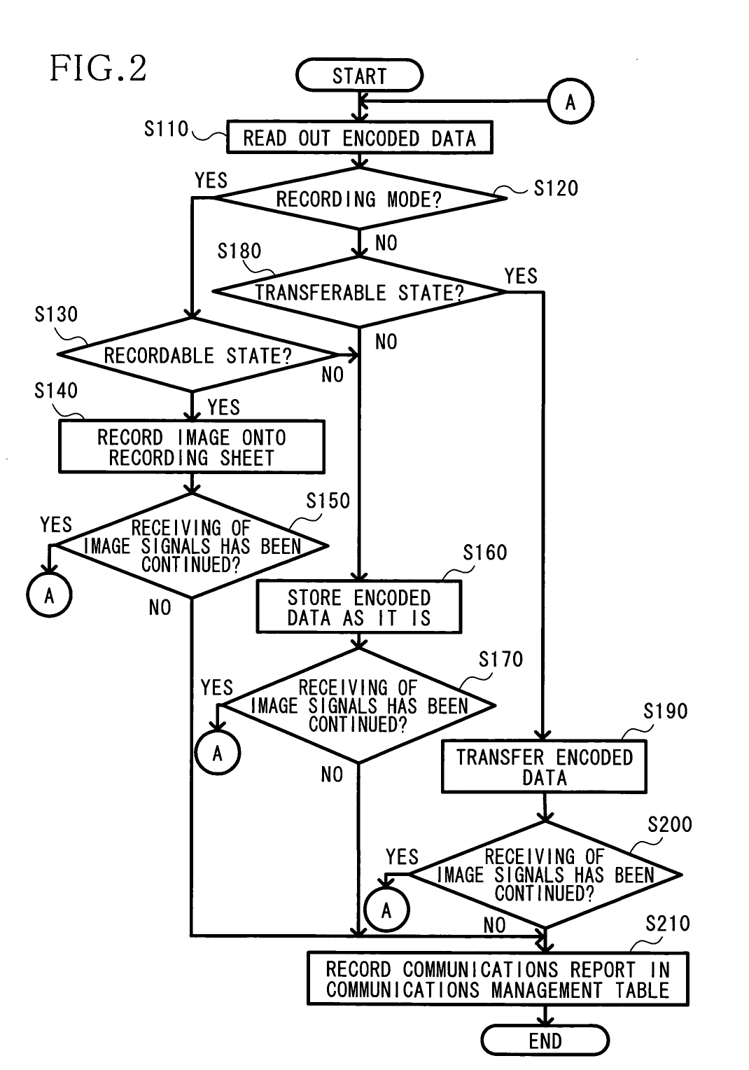

Referring to FIG. 2, a facsimile receiving process will be described below. This process is to be executed by the CPU 12 when the facsimile machine 1 starts receiving image signals from the telephone line network 100.

First, a page of encoded data which has been received via the modem 26 is read from the RAM 16 (S110).

Then, an operating mode of the facsimile machine 1 is determined (S120). The operating mode is determined by referring to a value set to a mode flag M that is stored in the RAM 16. When the value of the mode flag M is “0 (zero)”, it is determined that the facsimile machine 1 is in a recording mode where the facsimile machine 1 records image data onto a recording sheet by means of the printing portion 24. When the value of the mode flag M is “1 (one)”, it is determined that the facsimile machine 1 is in a transfer mode where the facsimile machine 1 transfers encoded data to the PC 2. As an initial value (which is a value at the time of start-up of the facsimile machine 1), “0” is set to the mode flag M. In accordance with a user's operation performed at a mode setting process (described later), the value of the mode flag M is switched between “1” and “0”.

At S120, when the operating mode of the facsimile machine 1 is the recording mode (S120:YES), it is determined whether the facsimile machine 1 is in a state of being capable of recording an image onto a recording sheet by means of the printing portion 24 (which is, hereinafter, referred to as a recordable state) (S130). The determination of S130 is made by monitoring an occurrence of problems, for example, empty of toner, empty of recording sheets, or a paper jam, by using sensors (not shown) that are built in the printing portion 24. When an occurrence of such problems is not detected, it is determined that the facsimile machine 1 is in the recordable state. In this embodiment, the well-known structures are employed to detect such problems, so that detailed descriptions of the structures will be omitted.

At S130, when the facsimile machine 1 is in the recordable state (S130:YES), an image represented by a page of the encoded data read at S110 is developed into image data and then is recorded onto a recording sheet by the printing portion 24 (S140).

Then, it is determined whether the receiving of image signals via the modem 26 has been continued (S150). When the facsimile machine 1 is still receiving image signals via the modem 26 after S140 (S150:YES), flow goes back to S110. After that, by repeatedly performing the processing of S130 to S140 as described above, the recording of images represented by the read (received) encoded data is repeatedly performed.

At S130, when the facsimile machine 1 is not in the recordable state (S130:NO), the encoded data read at S110 is stored as it is in the RAM 16, (S160).

Then, it is determined whether receiving of image signals via the modem 26 has been continued (S170). When the facsimile machine 1 is still receiving image signals via the modem 26 after S160 (S170:YES), flow goes back to S110. After that, by repeatedly performing the processing of S130, S160, and S170, the storing of the encoded data read at S110 into the RAM 16 is repeatedly performed.

At S120, when the operating mode of the facsimile machine 1 is not in the recording mode (S120:NO), it is determined whether the facsimile machine 1 is in a state of being capable of transferring encoded data to the PC 2 (which is, hereinafter, referred to as a transferable state) (S180). The PC 2 of the exemplary embodiment is installed with software for implementing the data communications with the facsimile machine 1 based on a predetermined communication procedure (e.g. “CLASS 2” which is a control procedure of facsimile communications) and the storage of encoded data received from the facsimile machine 1 is stored into an internal hard disk. Thus, at S180, it is determined whether the software (and the PC 2) is running by performing the data communications between the facsimile machine 1 and the PC 2 in accordance with the above procedure. When the software (and the PC 2) is running, it is determined that the facsimile machine 1 is in the transferable state.

At S180, when the facsimile machine 1 is not in the transferable state (S180:NO), flow moves to S160 to store the encoded data read at S110 into the RAM 16.

When the facsimile machine 1 is in the transferable state (S180:YES), the encoded data read at S110 is transferred to the PC 2 (S190).

Then, it is determined whether the receiving of image signals via the modem 26 has been continued (S200). When the facsimile machine 1 is still receiving image signals via the modem 26 after S190 (S200:YES), flow goes back to S110. After that, by repeatedly performing the processing of S1180 to S200, the transfer of the encoded data read at S110 to the PC 2 is repeatedly performed.

When, at S150, S170, and S200, it is determined that the receiving of the image signals via the modem 26 is finished (S150:N0, S170:N0, S200:NO), a communications report is recorded in a communications management table (S210) and then the facsimile receiving process is finished. At S210, as the communications report, for example, a communications date and time when the receiving of the image signals was started, a sender's facsimile number, a communications type (receiving), a total number of pages received through the communication, and a time period that was required to complete the communications, are recorded in the communications management table. The recording of a communications report into the communications management table is performed not only during the facsimile receiving process but also after the transmission of image signals performed by the facsimile machine 1 is completed. In this case, as the communications report, for example, a date and time when the transmission of the image signals was started, a receiver's facsimile number, a communications type (sending), a total number of pages transmitted through the communication, and a time period that was required to complete the communications, are recorded in the communications management table.

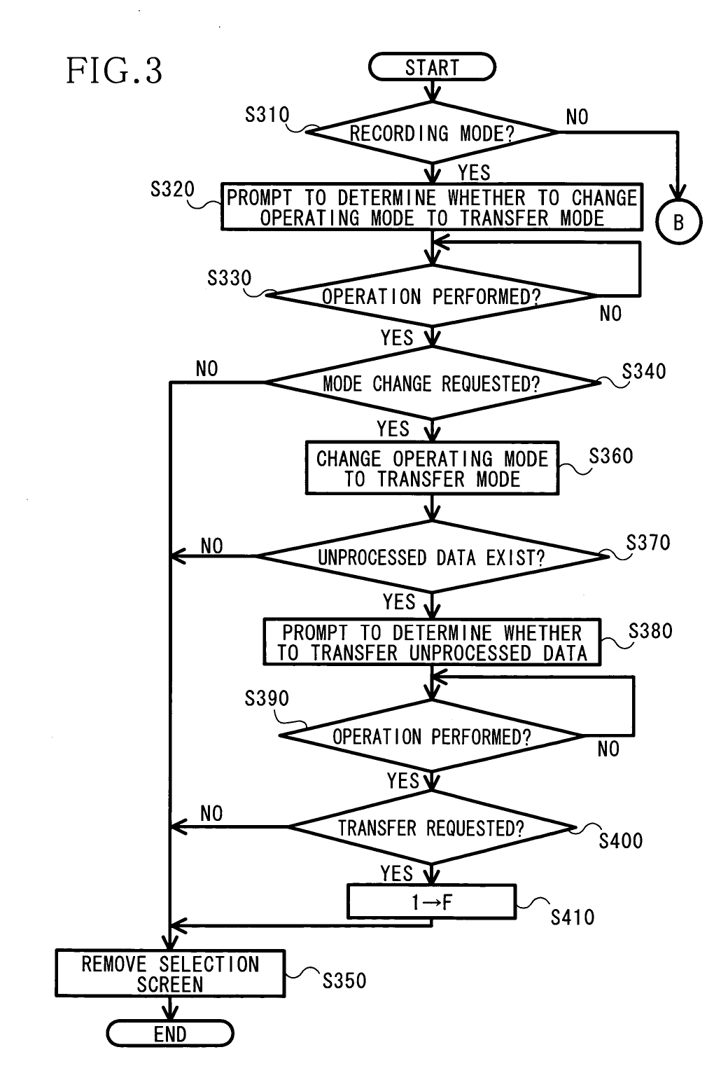

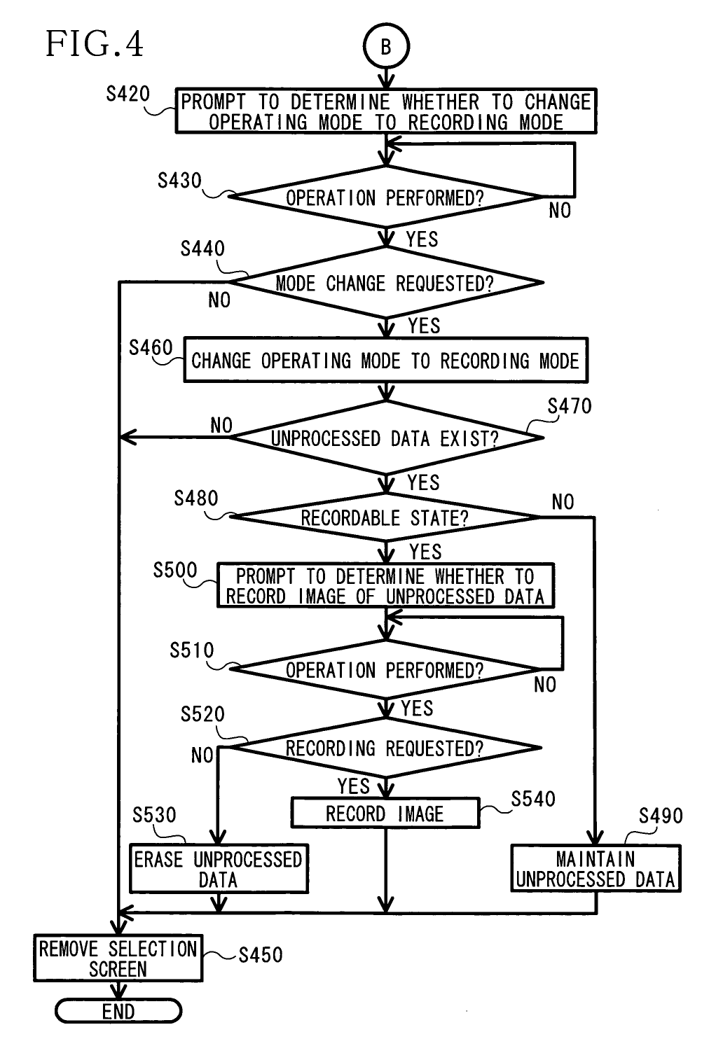

Referring to FIGS. 3 and 4, the mode setting process will be described below. This process is to be executed by the CPU 12 when an operation for changing the operating mode of the facsimile machine 1 is performed through the control panel 34.

First, the operating mode of the facsimile machine 1 is determined (S310). Similar to the processing of S120 of FIG. 2, when the value of the mode flag M is “1”, it is determined that the operating mode is the transfer mode. When the value of the mode flag M is “0”, it is determined that the operating mode is the recording mode.

At S310, when the operating mode is the recording mode (S310:YES), a selection screen is displayed on the display panel 36 to prompt a user to determine whether to change the operating mode to the transfer mode (S320). Then, flow waits until the user operates the control panel 34 (S330:NO). After the selection screen is displayed on the display panel 36 at S320, the user can select an option of changing the operating mode to the transfer mode or not through the control panel 34.

When the user operates the control panel 34 after the selection screen is displayed on the display panel 36 (S330:YES), the user's operation is determined (S340). When the operation for not changing the operating mode is performed (S340:NO), the selection screen displayed on the display panel 36 is removed (S350) and the mode setting process is finished. When the operation for changing the operating mode to the transfer mode is performed (S340:YES), the operating mode is switched to the transfer mode (S360). By setting “1” to the mode flag M, the operating mode is switched to the transfer mode.

Next, it is determined whether there is unprocessed encoded data (hereinafter, referred to as unprocessed data) stored in the RAM 16 (S370). The unprocessed data refers to the encoded data that was stored into the RAM 16 at S160 of FIG. 2 because it has not been recorded onto a recording sheet even when the facsimile machine 1 was in the recording mode at that time or it has not been transferred to the PC 2 even when the facsimile machine 1 was in the transfer mode at that time.

At S370, when there is no unprocessed data stored in the RAM 16 (S370:NO), flow moves to S350 to disappear the selection screen. Then, the mode setting process is finished. When there is unprocessed data stored in the RAM 16 (S370:YES), another selection screen is displayed on the display panel 36 to prompt the user to determine whether to transfer the unprocessed data to the PC 2 (S380). After that, flow waits until the user operates the control panel 34 (S390:NO). After the selection screen is displayed on the display panel 36 at S380, the user can select an option of transferring the unprocessed data to the PC 2 through the control panel 34.

When the user operates the control panel 34 after the selection screen is displayed on the display panel 36 (S390:YES), the user's operation is determined (S400). When the operation for not transferring the unprocessed data is performed (S400:NO), flow moves to S350 to remove the selection screen displayed on the display panel 36 and the mode setting process is finished. When the operation for transferring the unprocessed data is performed (S400:YES), “1” is set to a transfer flag F (1→F) (S410). Then, flow moves to S350 to remove the selection screen displayed on the display panel 36 and the mode setting process is finished. The transfer flag F is referred to when it is determined whether a transfer process is performed. The transfer flag F is stored in the RAM 16 with “0” of an initial value set thereto.

At S310, when the operating mode of the facsimile machine 1 is the transfer mode (S310:NO), another selection screen is displayed on the display panel 36 to prompt the user to determine whether to change the operating mode to the recording mode (S420). Then, flow waits until the user operates the control panel 34 (S430:NO). After the selection screen is displayed on the display panel 36 at S420, the user can select an option of changing the operating mode to the recording mode or not through the control panel 34.

When the user operates the control panel 34 after the selection screen is displayed on the display panel 36 (S430:YES), the user's operation is determined (S440). When the operation for not changing the operating mode is performed (S440:NO), the selection screen displayed on the display panel 36 is removed (S450) and the mode setting process is finished. When the operation for changing the operating mode to the recording mode is performed (S440:YES), the operating mode is switched to the recording mode (S460). By setting “0” to the mode flag M, the operating mode is switched to the recording mode.

Next, it is determined whether there is unprocessed data stored in the RAM 16 (S470). The unprocessed data refers to the encoded data that was stored in the RAM 16 at S1160 of FIG. 2, as described above.

At S470, when there is no unprocessed data stored in the RAM 16 (S470:NO), flow moves to S450 to remove the selection screen and the mode setting process is finished. When there is unprocessed data stored in the RAM 16 (S470:YES), it is determined whether the facsimile machine 1 is in the recordable state (S480). At S480, similar to the processing of S1130 of FIG. 2, it is determined that the facsimile machine 1 is in the recordable state when an occurrence of the problems is not detected.

At S480, when the facsimile machine 1 is not in the recordable state (S480:NO), the unprocessed data stored in the RAM 16 is maintained therein (S490). Then, flow moves to S450 to remove the selection screen and the mode setting process is finished.

At S480, when the facsimile machine 1 is in the recordable state (S480:YES), another selection screen is displayed on the display panel 36 to prompt the user to determine whether to record an image represented by the unprocessed data onto a recording sheet (S500). Then, flow waits until the user operates the control panel 34 (S510:NO). After the selection screen is displayed on the display panel 36 at S500, the user can select an option of recording an image represented by the unprocessed data through the control panel 34.

When the user operates the control panel 34 after the selection screen is displayed on the display panel 36 (S510:YES), the user's operation is determined (S520). When the operation for not recording an image is performed (S520:NO), the unprocessed data is erased from the RAM 16 (S530). Then, flow moves to S450 to remove the selection screen and the mode setting process is finished. When the operation for recording an image is performed (S520:YES), an image represented by the unprocessed data is recorded onto a recording sheet by the printing portion 24 (S540). Then, flow moves to S450 to remove the selection screen and the mode setting process is finished. At S540, while an image represented by the unprocessed data is recorded, the unprocessed data representing the recorded image is erased from the RAM 16.

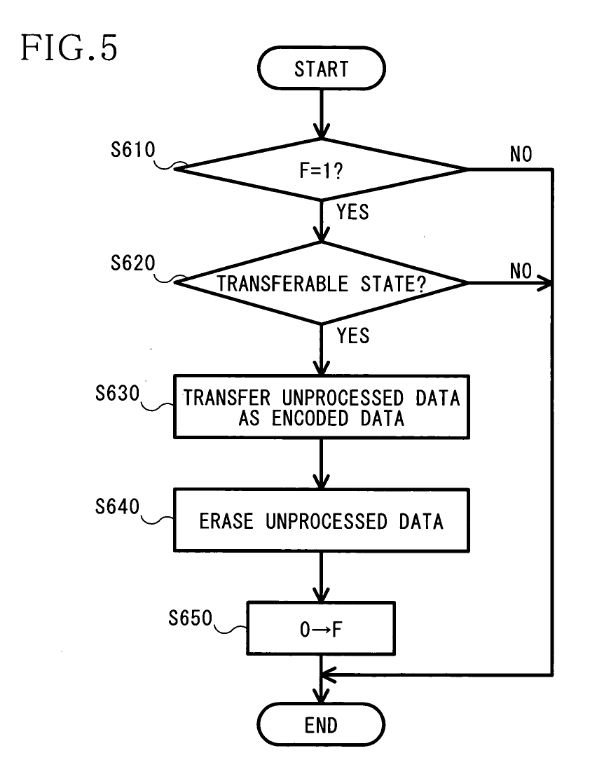

Referring to FIG. 5, the transfer process will be described below. This process is to be repeatedly performed at predetermined intervals (every 10 seconds in the exemplary embodiment) while the operating mode of the facsimile machine 1 is set to the transfer mode.

First, it is determined whether “1” has been set to the transfer flag F (F=1?) (S610). When the user selected the option of transferring the unprocessed data to the PC 2 at S410 of FIG. 3, “1” has been set to the transfer flag F. At S610, it is determined whether the setting for transferring the unprocessed data to the PC 2 has been made.

At S610, when “1” has not been set to the transfer flag F (S610:NO), the transfer process is finished. When “1” has been set to the transfer flag F (S610:YES), it is determined whether the facsimile machine 1 is in the transferable state (S620). Similar to the processing of S180 of FIG. 2, the determination is made through the data communications between the facsimile machine 1 and the PC 2.

At S620, when the facsimile machine 1 is not in the transferable state (S620:NO), the transfer process is finished.

When the facsimile machine 1 is in the transferable state (S620:YES), the unprocessed data stored in the RAM 16 is transferred to the PC 2, as encoded data (S630) and then the unprocessed data is erased from the RAM 16 (S640).

After that, “0” is set to the transfer flag F (0→F) (S650), and then the transfer process is finished.

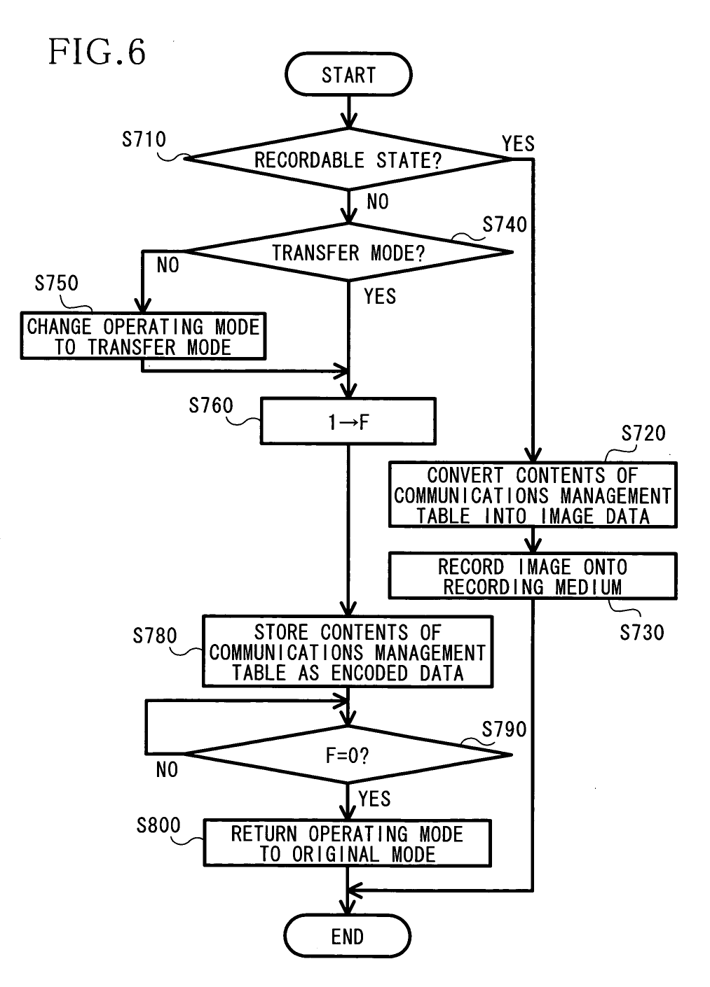

Referring to FIG. 6, a communications management report output process will be described below. This process is to be executed by the CPU 12 when an operation for instructing a recording of the contents of the communications management table onto a recording sheet is performed through the control panel 34 or when a predetermined time has elapsed (the total number of the reports recorded in the communications management table exceeds 50).

First, it is determined that the facsimile machine 1 is in the recordable state (S710). At S710, similar to the processing of S130 of FIG. 2, it is determined that the facsimile machine 1 is in the recordable state when an occurrence of the problems is not detected.

When the facsimile machine 1 is in the recordable state (S710:YES), the contents of the communications management table are converted into image data (S720). Then, an image represented by the converted image data is recorded on a recording sheet by the printing portion 24 (S730), and the communications management report output process is finished.

When the facsimile machine 1 is not in the recordable state (S710:NO), the operating mode of the facsimile machine 1 is determined whether it is the transfer mode (S740). Similar to the processing of S120 of FIG. 120, when the value of the mode flag M is “1”, it is determined that the operating mode is the transfer mode.

At S740, when the operating mode of the facsimile machine 1 is not in the transfer mode (S740:NO), the operating mode is switched to the transfer mode (S750) and then “1” is set to the transfer flag F (1→F) (S760). When the operating mode of the facsimile machine 1 is the transfer mode (S740:YES), “1” is set to the transfer flag F (S760) without changing the operating mode of the facsimile machine 1.

Next, contents of the communications management table are stored in the RAM 16 as encoded data (S780).

As described above, after “1” is set to the transfer flag F at S760 and the encoded data is stored at S780, the above described transfer process of FIG. 5 is performed. Thus, the encoded data (regarded as unprocessed data) representing the contents of the communications management table is transferred to the PC 2. After the encoded data is transferred to the PC 2, “0” is set to the transfer flag F at S650 of FIG. 5. Accordingly, with the change of the value of the transfer flag F, it can be confirmed that the encoded data representing the contents of the communications management table has been transferred to the PC 2.

After the encoded data is stored in the RAM 16 at S780, flow waits until “0” is set to the transfer flag F, that is, until the encoded data representing the contents of the communications management table is transferred to the PC 2 (S790:NO). When the transfer of the encoded data is completed (S790:YES), the operating mode is returned to the original mode (S800), and the communications management report output process is finished. At S800, only when the operating mode was switched to the transfer mode at S760, the operating mode is returned to the recording mode by setting “0” to the transfer flag F. If the operating mode was not changed at S760, the operating mode is not changed.

In the facsimile system structured as described above, when the change of the operating mode at S330 of FIG. 3 and at S430 of FIG. 4 is performed while there is encoded data that has not been confirmed yet by the user, that is, unprocessed data, stored in the RAM 16 (S370, S470), the facsimile machine 1 can handle the unprocessed data at S380 and subsequent steps or at S480 and subsequent steps, regardless of whether the user knows that the unprocessed data remains in the RAM 16. Therefore, if the user restarts the facsimile machine 1, turns the power of the facsimile machine 1 off, or performs an operation to erase the data stored in the RAM 16 after the above processing is performed, there is no unprocessed data remaining in the RAM 16 at that time. Thus, the unprocessed encoded data can be prevented from being accidentally erased while maintained in the RAM 16.

Further, at S380 of FIG. 3 and at S500 of FIG. 4, the user's confirmation is required before the operating mode is changed. Accordingly, these steps make the user acknowledge the existence of unprocessed data. In addition, these steps allow the user to select the option of processing the unprocessed data or not (S400 and S520).

In the above described exemplary embodiment, when there is unprocessed data stored in the RAM 16 at the time the operating mode is switched from the transfer mode to the recording mode through S400 to S470 of FIG. 4, an image represented by the unprocessed data is recorded by the printing portion 24. That is, when the operating mode is switched to the recording mode, the unprocessed data, which has not been transferred to the PC 2 due to some reason while the operating mode of the facsimile machine 1 is the transfer mode, is processed by the printing portion 24. More specifically, an image represented by the unprocessed data is recorded onto a recording medium when the operating mode is switched to the recording mode. By doing so, the user can confirm the unprocessed data.

When there is unprocessed data stored in the RAM 16 at the time the operating mode is switched from the recording mode to the transfer mode through S340 to S370 of FIG. 3, “1” is set to the transfer flag F (S410) and the transfer process (FIG. 5) is performed in order to transfer an image represented by the unprocessed data to the PC 2. That is, when the operating mode is switched to the transfer mode, the unprocessed data, which has not been recorded onto a recording medium due to some reason while the operation mode of the facsimile machine 1 is the recording mode, is transferred to the PC 2. By doing so, the user can confirm the unprocessed data by using the PC 2.

At S480 of FIG. 4, before the facsimile machine 1 allows the printing portion 24 to record an image represented by encoded data, it is determined whether the facsimile machine 1 is in the recordable state. When the facsimile machine 1 is in the recordable state, the image is recorded (S540). When the facsimile machine 1 is not in the recordable state, the storage of the encoded data (the unprocessed data) in the RAM 16 is maintained (S490). Accordingly, when the facsimile machine 1 is not in the recordable state, the remaining encoded data is temporarily maintained in the RAM 16 and then is to be transferred to the PC 2, as the unprocessed data, at the time the operating mode is switched to the transfer mode from the recording mode the next time. Therefore, if the user restarts the facsimile machine 1, turns the power of the facsimile machine 1 off, or performs an operation to erase the data stored in the RAM 16 after the operating mode is switched to the transfer mode, there is no unprocessed data remaining in the RAM 16 at that time. Thus, the unprocessed encoded data can be prevented from being accidentally erased while maintained in the RAM 16.

At S620 of FIG. 5, it is determined whether encoded data can be transferred to the PC 2, through data communications between the facsimile machine 1 and the PC 2. When the facsimile machine 1 is in the transferable state, the facsimile machine 1 transfers the encoded data (the unprocessed data) to the PC 2 (S630). When the facsimile machine 1 is not in the transferable state, the storage of the encoded data in the RAM 16 is maintained. Accordingly, when the facsimile machine 1 is in the transferable state, the remaining encoded data is temporarily maintained in the RAM 16 and then is to be recorded onto a recording sheet, as the unprocessed data, at the time the operating mode is switched to the recording mode from the transfer mode the next time. Therefore, if the user restarts the facsimile machine 1, turns the power of the facsimile machine 1 off, or performs an operation to erase the data stored in the RAM 16 after the operating mode is switched to the recording mode, there is no unprocessed encoded data remaining in the RAM 16 at that time. Thus, the unprocessed encoded data can be prevented from being accidentally erased while maintained in the RAM 16.

At the communications management report output process of FIG. 6, when the facsimile machine 1 (the printing portion 24) is not in the recordable state at the time of recording the communications management table onto a recording sheet (S710:NO), the contents of the communications management table are stored in the RAM 16 (S780). At that time, the contents of the communications management table are stored as encoded data, so that the encoded data representing the contents of the communications management table is to be transferred to the PC 2, as unprocessed data, when the operating mode of the facsimile machine 1 is switched to the transfer mode. As described above, the user can confirm the contents of the communications management table by using the PC 2 even when the contents of the communications management table cannot be recorded onto a recording sheet by the printing portion 24.

Although the various exemplary aspects of this disclosure have been described in detail with reference to the specific embodiments thereof, it would be apparent to those skilled in the art that various changes, arrangements and modifications may be applied therein without departing from the spirit and scope of the disclosure.

In the above-described exemplary embodiment, the operating mode of the facsimile machine 1 is switched upon receipt of an instruction from the user. Alternatively, for example, the operating mode of the facsimile machine 1 may be changed when the facsimile machine 1 receives a command from other device that can perform data communications with the facsimile machine 1 or at a predetermined timing (e.g. time).

In the above-described exemplary embodiment, the user's confirmation is required at S380 of FIG. 3 and at S500 of FIG. 4 when the operating mode is switched. Alternatively, unprocessed data may be immediately processed without user's confirmation. In this case, flow skips S380 to S400 and moves straight from S370 to S410 in FIG. 3, and flow skips S500 to S530 of and moves straight from S480 to S540 in FIG. 4.

In the above-described exemplary embodiment, unprocessed data is processed by the recording process when the user selects the recording mode by the mode switching device, and by the transferring process when the user selects the transferring mode by the mode switching device, on the condition that the user accepts to process the unprocessed data. Alternatively, unprocessed data may be processed by at least one of a plurality of processes other than recording process and transferring process when the operating mode is switched.

In the above-described exemplary embodiment, at the communications management report output process of FIG. 6, the communications management report is recorded by the printing portion 24 or is transferred to the PC 2. In addition, other data, for example, data representing operation details of the facsimile machine 1, may be recorded by the printing portion 24 or is transferred to the PC 2 by employing the procedures similar to the communications management report output process.

In the above-described exemplary embodiment, the RAM 16 of the facsimile machine 1 functions as a storage device. The printing portion 24 of the facsimile machine 1 functions as a recording device. The PC 2 functions as a terminal device.

The processing of S360 of FIG. 3, the processing of S460 of FIG. 4, the processing of S750 and S800 of FIG. 6 function as a mode switching device. The processing of S190 of FIG. 2 and the processing of S630 of FIG. 5 function as a transfer device. The processing of S410 of FIG. 3, the processing of S490 of FIG. 4, and the processing of S610 to S650 of FIG. 5 function as a data processing device. The processing of S380, and the processing of S390 of FIG. 3, and the processing of S500 and S510 of FIG. 4 function as a selecting device. The processing of S180 of FIG. 2 and the processing of S480 of FIG. 4 function as a judging device. The processing of S710 to S780 of FIG. 6 functions as a recording operation commanding device. The communication management table to be used in the processing of S710 to S780 functions as operation data.

The image signals received by the line control portion 28 and the communications details obtained by the receiving of the image signals function as data obtained from an external source.

In some exemplary embodiments, a facsimile machine may include a storage device that stores data based on information obtained from an external source, a recording device that records an image represented by the data stored in the storage device, a transfer device that transfers the data stored in the storage device to a terminal device capable of performing data communications, a mode switching device that switches an operating mode of the facsimile machine between a recording mode of recoding the image represented by the data stored in the storage device by means of the recording device, and a transfer mode of transferring the image data by means of the transfer device, and a data processing device that processes unprocessed data, which is the data stored in the storage device and has not been recorded or transferred yet, by employing one of processing methods including at least the processing performed by the recording device and the processing performed by the transfer device, when the operating mode is switched by the mode switching device.

According to the above-described exemplary structure, when the switching of the operating mode is performed while there is encoded data that has not been confirmed yet by the user, that is, unprocessed data that has not been processed yet, remaining in the storage device, the unprocessed data can be processed regardless of whether the user has acknowledged that the unprocessed data remains in the storage device. Therefore, if the user restarts the facsimile machine, turns the power of the facsimile machine off, or performs an operation to erase the data stored in the storage device after the above processing is performed, there is no unprocessed data remaining in the storage device at that time. Thus, the unprocessed encoded data can be prevented from being accidentally erased while maintained in the storage device.

The switching device switches the operating mode between the recording mode and the transfer mode. The switching of the operating mode may be performed, for example, when the facsimile machine receives an instruction from the user, when the facsimile machine receives a command from other device that can perform data communications with the facsimile machine, or at a predetermined timing (e.g. time).

In some exemplary embodiments, the data processing device may be arranged so as to immediately process unprocessed data in accordance with the switching of the operating mode. Alternately, the data processing device may be arranged so as to ask the user whether the processing of unprocessed data is performed.

According to the above-described exemplary structure, the user can acknowledge that unprocessed data exists in the storage device. In addition, the user can be allowed to select an option of processing the unprocessed data or not.

In some embodiments, the data processing device may be arranged so as to perform any process when the operating mode is switched.

According to the above-described exemplary structure, unprocessed data, which was not transferred to the terminal device due to some problem while the operating mode was the transfer mode, is processed by the recording device when the operating mode is switched to the recording mode. More specifically, an image represented by the unprocessed data is recorded onto a recording medium when the operating mode is switched to the recording mode. By doing so, the user can confirm the unprocessed data.

There may be cases where the recording of an image by the recording device cannot be normally performed due to a breakdown in the recording device or lack of ink. As a kind of insurance against the above cases, for example, the facsimile machine may be arranged such that the data processing device performs the recording of an image represented by encoded data onto a recording medium when the recording of the image can be performed by the recording operation, and the data processing device maintains the storage of the encoded data in the storage device when the recording of the image by the recording device cannot be performed.

According to the above-described exemplary structure, when the recording of the image by the recording device cannot be performed, the encoded data is maintained in the storage device. The maintained encoded data is then to be transferred to the terminal device, as unprocessed data, when the operating mode is switched from the recording mode to the transfer mode by the switching device the next time. Therefore, if the user restarts the facsimile machine, turns the power of the facsimile machine off, or performs an operation to erase the data stored in the storage device after the above processing is performed, there is no unprocessed data remaining in the storage device at that time. Thus, the unprocessed encoded data can be prevented from being accidentally erased while maintained in the storage device.

In some embodiments, it may be arranged such that when the mode switching device switches the operating mode from the recording mode to the transfer mode, the data processing device allows the transfer device to process the unprocessed data if the unprocessed data exists in the storage device.

According to the above-described exemplary structure, unprocessed data, which was not recorded onto a recording medium due to some problem while the operating mode was the recording mode, can be transferred to the terminal device by the transfer device at the time the operating mode is switched to the transfer mode. By doing so, the user can confirm the unprocessed data by using the terminal device.

There may be cases where the transfer of unprocessed data by the transfer device cannot be normally performed due to troubles that occurred in the terminal device. Therefore, in some embodiments, the facsimile machine may further include a judging device that judges whether the transfer of the data to the terminal device is performable by the transfer device, through data communications with the terminal device. The data processing device may allow the transfer device to transfer the data to the terminal device when the judging device judges that the transfer is performable by the transfer device, and may allow the storage device to maintain the data therein when the judging device judges that the transfer is not performable by the transfer device.

According to the above-described exemplary structure, when the transfer of encoded data by the transfer device cannot be performed, the storage of the encoded data maintained in the storage device. The maintained encoded data is then to be recorded onto a recording medium, as unprocessed data, when the operating mode is switched from the transfer mode to the recording mode by the switching device. Therefore, if the user restarts the facsimile machine, turns the power of the facsimile machine off, or performs an operation to erase the data stored in the storage device after the above processing is performed, there is no unprocessed data remaining in the storage device at that time. Thus, the unprocessed encoded data can be prevented from being accidentally erased while maintained in the storage device.

In some embodiments, the facsimile machine may further include a recording operation commanding device that generates operation data representing operation details of the facsimile machine, based on the information obtained from the external source, and allows the recording device to record the operation data. The recording operation commanding device may allow the storage device to store the operation data when the recording device is not in the state of being capable of recording the image.

According to the above-described exemplary structure, when the recording of an image by the recording device cannot be performed, operation data representing operation details of the facsimile machine is stored in the storage device. At that time, the operation data is stored therein as encoded data. After this processing is performed, the operation data is transferred to the terminal device, as unprocessed data, when the operating mode of the facsimile machine is switched to the transfer mode. As described above, even when the operation data cannot be recorded onto a recording medium by the recording device, the user can confirm the operation details represented by the operation data by using the terminal device.

The operation data to be recorded or stored in accordance with an instruction from the recording operation commanding device, may include, for example, a date and time when facsimile communications was performed with an external source and information about the external source with which the facsimile machine performed the facsimile communications.

When the operation data includes such the above-described data, the user can confirm the date and time when the facsimile communications was performed with the external source and the information about the external source by means of a recording medium on which the operation data is recorded by the recording device or by means of the terminal device to which the operation data has been transferred.

The program for allowing a computer system to execute the above processes may be provided to a computer system or a user who uses the computer system, through a recording medium, such as an floppy disk, a CD-ROM, and a memory card, or a communications line network, such as the Internet. The program may be preinstalled in an internal hard disk or an internal memory of the computer system in order to provide the program to the user. For the computer system that executes the program, a computer system equipped with the above-described facsimile machine, and other computer system that can perform data communications with the facsimile machine.

1. A facsimile machine for communicating with an external source, comprising:
a mode switching device that selects one of a plurality of modes, each of which corresponds to each of a plurality of processes, respectively, the plurality of processes comprising a recording process recording an image represented by data based on information obtained from an external source and a transferring process transferring the data based on the information obtained from the external source;
a processing device that processes the data based on the information obtained from the external source by the process to which the one of the plurality of the modes selected by the mode switching device corresponds;
a controlling device controls the processing device to process data which is remaining without being processed by the processing device at the time the one of the plurality of the processing modes is selected by the mode switching device.

2. The facsimile machine according to claim 1, further comprising a selecting device that allows a user to select an option of processing unprocessed data or not, when an operating mode is switched by the mode switching device,
wherein the controlling device processes the unprocessed data when the option of processing the unprocessed data is selected by the selecting device after the operating mode is switched by the mode switching device.

3. The facsimile machine according to claim 1, wherein when the mode switching device switches an operating mode from a transfer mode to a recording mode, the controlling device allows a recording device to process unprocessed data if the unprocessed data exists in a storage device.

4. The facsimile machine according to claim 1, wherein the processing device includes a storage device that stores the data based on information obtained from the external source.

5. The facsimile machine according to claim 4, wherein the controlling device determines whether there is the data, which is remaining without being processed by the processing device in the storage device.

6. The facsimile machine according to claim 5, wherein the controlling device allows a recording device to record the image represented by the data onto a recording medium when the recording device is in a state of being capable of recording the image, and allows the storage device to maintain the data therein when the recording device is not in the state of being capable of recording the image.

7. The facsimile machine according to claim 1, wherein when the mode switching device switches from a recording mode to a transfer mode, the controlling device allows a transfer device, that transfers the data stored in a storage device to a terminal device capable of performing data communications, to process a unprocessed data if the unprocessed data exists in the storage device.

8. The facsimile machine according to claim 7, further comprising a judging device that judges whether the transfer of the data to the terminal device is performable by the transfer device, through data communications with the terminal device,
wherein the controlling device allows the transfer device to transfer the data to the terminal device when the judging device judges that the transfer is performable by the transfer device, and allows the storage device to maintain the data therein when the judging device judges that the transfer is not performable by the transfer device.

9. The facsimile machine according to claim 1, further comprising a recording operation commanding device that generates operation data representing operation details of the facsimile machine, based on the information obtained from the external source, and allows a recording device to record the operation data,
wherein the recording operation commanding device allows a storage device to store the operation data when the recording device is not in the state of being capable of recording the image.

10. The facsimile machine according to claim 9, wherein the recording operation commanding device generates data that represents a date and time when facsimile communications were performed with the external source and information about the external source.

11. A facsimile system, comprising:
the facsimile machine of claim 1; and
a terminal device connected with the facsimile machine so as to be able to perform data communications therebetween.

12. A computer readable medium containing a computer program that allows a computer system to execute processing procedures that function, as the mode switching device of claim 1, the processing device of claim 1, and the controlling device of claim 1.

13. A method of processing encoded data in a facsimile machine, comprising:
selecting one of a plurality of operating modes, each of which corresponds to each of a plurality of processes, respectively, the plurality of processes comprising a recording process recording an image represented by data based on information obtained from an external source and a transferring process transferring the data based on the information obtained from information obtained from the external source;
processing the data based on the information obtained from the external source by the process corresponding to the one of the plurality of the operating modes selected;
controlling the processing to process unprocessed data not processed at the time the one of the plurality of operating modes is selected.

14. The method of claim 13, further comprising determining whether to process unprocessed data when switching between the operating modes of the facsimile machine.

15. The method of claim 13, further comprising recording the unprocessed data when the operating mode is switched from a data transfer mode to a data record mode.

16. The method of claim 13, further comprising:
determining whether a recording device of the facsimile machine is in a state capable of recording the image;
allowing the recording device to record when in the state capable of recording the image; and
maintaining the unprocessed data in the storage device when the recording device is not in the state capable of recording the image.

17. The method of claim 13, further comprising transferring the unprocessed data to a terminal device when the operating mode is switched from a data record mode to a data transfer mode.

18. The method of claim 13, further comprising:
determining whether a terminal device is in a state capable of receiving transfer of the unprocessed data;
allowing the terminal device to receive the unprocessed data when in the state capable of receiving the unprocessed data; and
maintaining the unprocessed data in the storage device when the terminal device is not in the state capable of receiving the unprocessed data.

19. The method of claim 13, further comprising:
generating operation data representing operation details of the facsimile machine, based on information obtained from the external source;
allowing a recording device to record the operation data; and
allowing a storage device to store the operation data when the recording device is not in a state capable of recording the image.

20. The method of claim 19, further comprising generating data that represents a date and time when facsimile communications were performed with the external source and information about the external source.

21. A facsimile machine, comprising:
mode switching means for selecting one of a plurality of modes, each of which corresponds to each of a plurality of processes, respectively, the plurality of processes comprising a recording process recording an image represented by data based on information obtained from an external source and a transferring process transferring the data based on information obtained from the external source;
processing means for processing the data based on information obtained from the external source by the process to which the one of the plurality of the modes selected by the mode switching means corresponds;
controlling means for controlling the processing means to process data which is remaining without being processed by the processing means at the time the one of the plurality of the processing modes is selected by the mode switching means.
